(19) United States
(12) Patent Application Publication
(10) Pub. No.: US 2010/0229665 A1
(43) Pub. Date: Sep. 16, 2010

(54) MODIFIED ECCENTRIC GEARBOX

(76) Inventor: Vishvas Prabhakar Ambardekar, Maharashtra (IN)

Correspondence Address: "Snehal" Apartments;Flat No. 1, Plot No. B-82, Tulshibwale Colony, Sahakar Nagar No. 2, Pune, 411009, IN

(21) Appl. No.: 12/734,345

(22) PCT Filed: Apr. 3, 2008
(86) PCT No.: PCT/IN2008/000215

§ 371 Date: Apr. 27, 2010

(30) Foreign Application Priority Data
Oct. 26, 2007 (IN) 2128/MUM/2007

(51) Int. Cl. F16H 3/04

(52) U.S. Cl. 74/332

(57) ABSTRACT

The invention deals with an eccentric gearbox with selectable, large speed ratio. A gearbox that consists of multiple eccentric gear pairs (12, 13 and 14,15), an eccentric gear pair is engaged between input (22) and output shafts (24) as to get corresponding speed ratio between the two shafts. In present invention, mechanisms are developed to disengage gears belonging to an eccentric gear pair that is not engaged between input (22) and output shafts (24) as to reduce wear and tear of the gears. In one approach variable eccentricity assemblies (16, 17) can make unengaged fixed gears (12, 14) stationary as to reduce energy consumption and vibrations also. In another approach, movement of revolving gears (13, 15) along output shaft axis (24) can engage or disengage gears of an eccentric gear pair (12,13 and 14, 15) as per the requirement. Use of common revolving gear (13, 15) or common fixed gear (12, 14) for multiple eccentric gear pairs (12,13 and 14, 15) can reduce inertia load on output shaft (24) and input shaft (22) respectively.

### BACKGROUND

A gearbox with large speed ratio is very useful. This type of gearbox can use eccentric gear pairs for obtaining large speed ratios; this makes it very compact in size, for large speed ratio. Eccentric gearbox can give high-speed ratio between input and output shafts. Such gearboxes find applications in automobiles, and in many other applications. Earlier eccentric gearbox has a drawback in that the gears of eccentric gear pairs are always in mesh and thus experience continuous wear and tear of the gears that may probably reduce the life of gearbox.

In present eccentric gearbox gears belonging to the eccentric gear pairs that are not engaged between input and output shafts are kept disengaged and thus reduces wear in such gears. Another improvement as compared to existing eccentric gearbox is that few of the gears that are not engaged between the input and output shafts, are stationary thus reducing the power consumed that would otherwise be needed to keep the gears moving.

### PRIOR ART

1. International Application No. PCT/IN2002/00143, titled “Eccentric Gearbox” international filing date Jul. 2, 2002, by Ambardekar, Vishvas Prabhakar.
2. Indian Patent No. 209028, dated Aug. 17, 2007, titled “Eccentric Gearbox”, based on application No. 767/MUMNP/2004, invented by Ambardekar, Vishvas Prabhakar.

### INTRODUCTION

Present invention deals with large speed ratio eccentric gearbox with selectable speed ratio and can be said to be a modified gearbox in comparison with eccentric gearbox as mentioned in Indian patent application No. 767/MUMNP/2004 and international patent application No. PCT/IN2002/00143. Eccentric gearboxes described in said patent applications use multiple eccentric gear pairs in parallel, and allow engagement of input and output shafts to any of the meshing eccentric gear pairs.

In design of above eccentric gearbox, gears belonging to individual eccentric gear pairs are always in mesh thus experience continuous wear, irrespective of their engagement between input and output shafts. Though wear of gears belonging to the eccentric gear pair that is engaged between input and output shafts for more duration will be higher than gears belonging to the eccentric gear pairs that are engaged between input and output shafts for a lesser duration.

Present invention has many improvements over to the above-mentioned eccentric gearbox. Present eccentric gearbox allows disengagement of gears belonging to an eccentric gear pair, which is not engaged between input and output shafts. Present eccentric gearbox can help in keeping few gears stationary if they are not engaged between input and output shafts. Few of the improvements in the present eccentric gearbox are achieved using variable eccentricity assembly as developed and filed on Oct. 26, 2007, as a patent application No. 2127/MUM/2007 titled “Variable Eccentricity Assembly” at the Indian Patent Office, Mumbai, India. Eccentric gearbox with only two or three speed ratios are described in following description, but eccentric gearbox with more number of speed ratios can be constructed on same principles as described below.

### DEFINITIONS

Internal gear—A circular gear with internal teeth.

External gear—A circular gear with external teeth.

Fixed gear—A circular gear that keeps its orientation fixed. Fixed gear is also called as fixed orientation gear.

Revolving gear—A circular gear that rotates about its own axis.

Pitch circle—A reference circle on a plane normal to the rotational axis of a spur gear, the diameter of the pitch circle is used for calculations. When two gears are in mesh, pitch circles of either gears roll over each other.

Pitch Cylinder—A cylinder, co-axial to the axis of a spur gear and passes through the pitch circle of the gear. As most of the time, the gear cross section is referred, only pitch circle is referred in the explanation that follows.

Point of contact—Theoretical common point on pitch circles of two meshing spur gears. The two pitch circles are tangential to each other at this point.

Line of contact—Theoretical common line on pitch cylinders of two meshing spur gears. Two pitch cylinders are tangential to each other at this line. This line is always parallel to the axes of the two gears and passes through the point of contact. As most of the time the gear cross section is referred, only point of contact is referred in the explanation that follows.

Eccentric gear Pair—An eccentric gear pair consists of a fixed gear and a revolving gear. One of the gears has internal teeth and another gear has external teeth. Number of internal teeth is more than number of external teeth. When in mesh, axes of the gears are at a distance that is called eccentricity of the eccentric gear pair. While in proper engagement, axes of the two gears relatively revolve around each other with a radius equal to the eccentricity of the eccentric gear pair.

Eccentricity—Half the difference between pitch circle diameters of two meshing circular gears forming an eccentric gear pair. The eccentricity should preferably be same for all eccentric parts related to a particular gear pair.

Variable eccentricity assembly—In present invention, a variable eccentricity assembly is considered as an assembly with a fixed shaft axis that can change its eccentricity, which is the distance between the shaft axis and another axis that revolve around the shaft axis, while allowing the shaft and the assembly to continue its rotation about the shaft axis, if so required. Few of the mechanisms to control the eccentricity of variable eccentricity assemblies are discussed in the patent application No. 2127/MUM/2007 filed in INDIA, on 26 Oct. 2007, titled “Variable Eccentricity Assembly”. Referring to the patent application as mentioned, in present invention, fixed gears are the output components for the variable eccentricity assembly and thus the outer eccentric part or the disc of it is mounted on the fixed gear and is able to rotate with respect to the fixed gear. In present description, a variable eccentricity assembly is schematically represented as a combination assembly of two eccentric parts in series. Henceforth a variable eccentricity assembly is denoted by VEA in its singular form and by VEAs in its plural form.

Principles of Operation:

Proper engagement of the two gears of an eccentric gear pair takes place when distance between their axes is equal to the eccentricity of the eccentric gear pair. If the axes of the two gears of an eccentric gear pair are moved towards each other, gears start coming out of engagement. If the tooth height of the teeth for the two gears is sufficiently less than the eccentricity of the eccentric gear pair and if the two axes are brought sufficiently near to each other or are aligned, the gears can be disengaged from each other. Aligning the two axes can make the fixed gear stationary.

Revolving gears belonging to eccentric gear pairs of an eccentric gearbox are connected to an output shaft such that the gears can move in a direction along its axis and rotate with the output shaft without slip, while fixed gears are restrained from moving along the axis. Revolving gears are locked at desired position along their axis so that gears of a selected eccentric gear pair are in mesh to give desired speed ratio between input and output shafts.

In yet another approach, fixed gears are arranged in such a way that a single revolving gear can be engaged with any of the fixed gears. In other words, eccentric gear pairs have common revolving gear and separate fixed gears. The common revolving gear and the fixed gears have matching teeth. The common revolving gear is connected to an output shaft such that it can move along its axis and rotate with the output shaft without slip. By locking the revolving gear at a desired position, it can be engaged with any desired fixed gear to engage selected eccentric gear pair between input and output shafts.

In another approach, revolving gears are connected to an output shaft as to rotate with it without slip and have no movement along their axis. A fixed gear that has its teeth matching to that of the revolving gears is movable in the direction along the axis of revolving gears. The fixed gear is mounted with VEAs that can change its eccentricity to suit to that of any eccentric gear pair formed by the fixed gear and one of the revolving gears. Thus by moving the fixed gear and locking it with respect to a revolving gear and simultaneously changing eccentricity of VEAs to an appropriate value, any of the eccentric gear pairs can be engaged between the input and the output shafts.

Speed ratio between input and output shafts for an eccentric gear pair depends upon which of the gears is fixed gear. For an eccentric gear pair that has internal gear with M number of teeth and external gear with N number of teeth, where M is greater than N, and with input is given to the eccentric attached to the fixed gear and revolving gear is mounted on output shaft, different speed ratios that can be obtained are as below:

Case—1: Internal gear is a fixed gear and external gear is a revolving gear. Speed ratio can be given by N:(M-N).

Case—2: External gear is a fixed gear and internal gear is a revolving gear. Speed ratio can be given by M:(M-N).

Present invention “modified eccentric gearbox”, describes different arrangements that use above-mentioned principles and are explained with the help of drawings. The drawings are briefly described below.

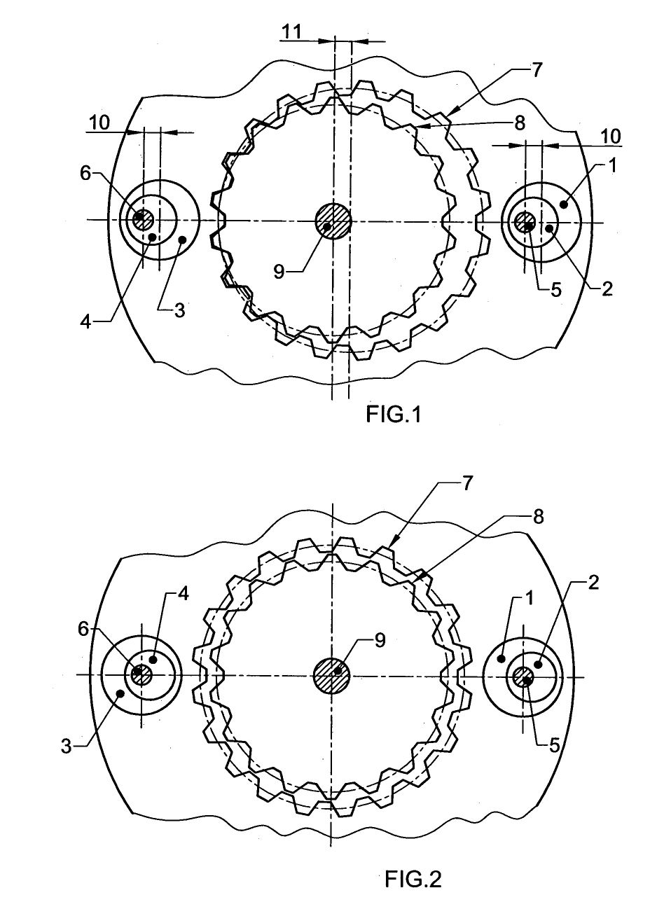

FIG. 1: Schematic view of gears of an eccentric gear pair in mesh. Overall eccentricity of the VEAs is equal to that of the eccentric gear pair.

FIG. 2: Schematic view of an eccentric gear pair with the gears shown disengaged from each other. Eccentricity of the VEAs is shown as zero.

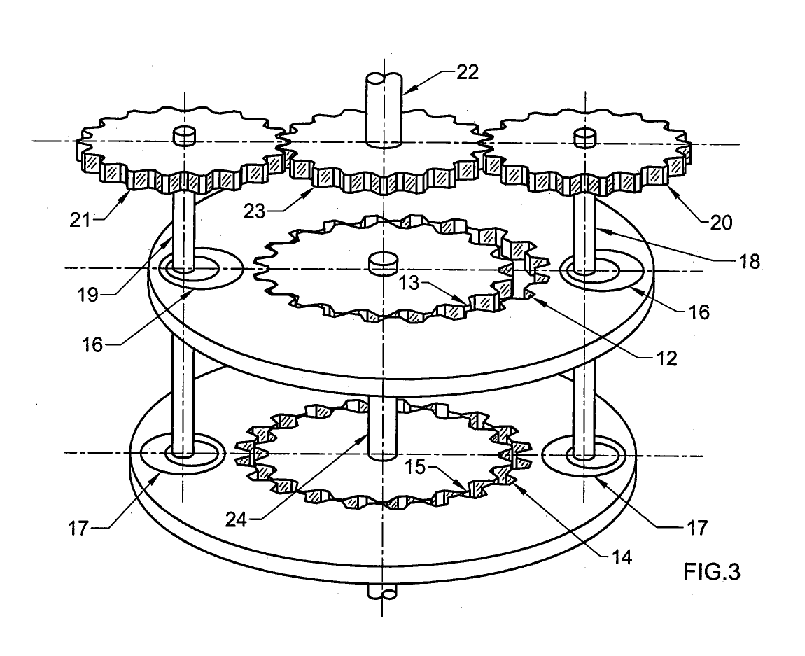

FIG. 3: Schematic view of an eccentric gearbox with two eccentric gear pairs. The gearbox is shown with two input shafts and one output shaft connected to each eccentric gear pair. One of the eccentric gear pairs is shown engaged while other is shown out of engagement.

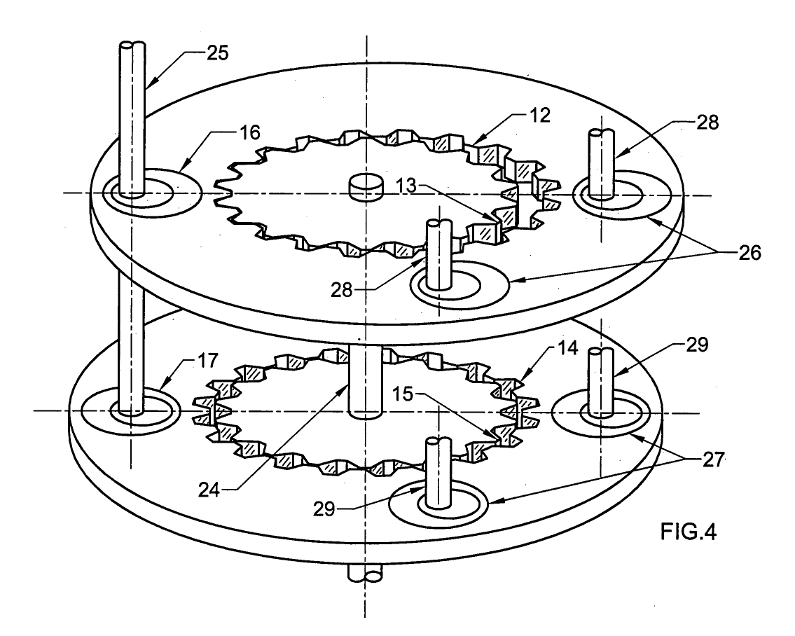

FIG. 4: Schematic view of an eccentric gearbox with two eccentric gear pairs. The gearbox is shown with one input shaft and one output shaft connected to each eccentric gear pair. One of the eccentric gear pair is shown engaged while other is shown out of engagement.

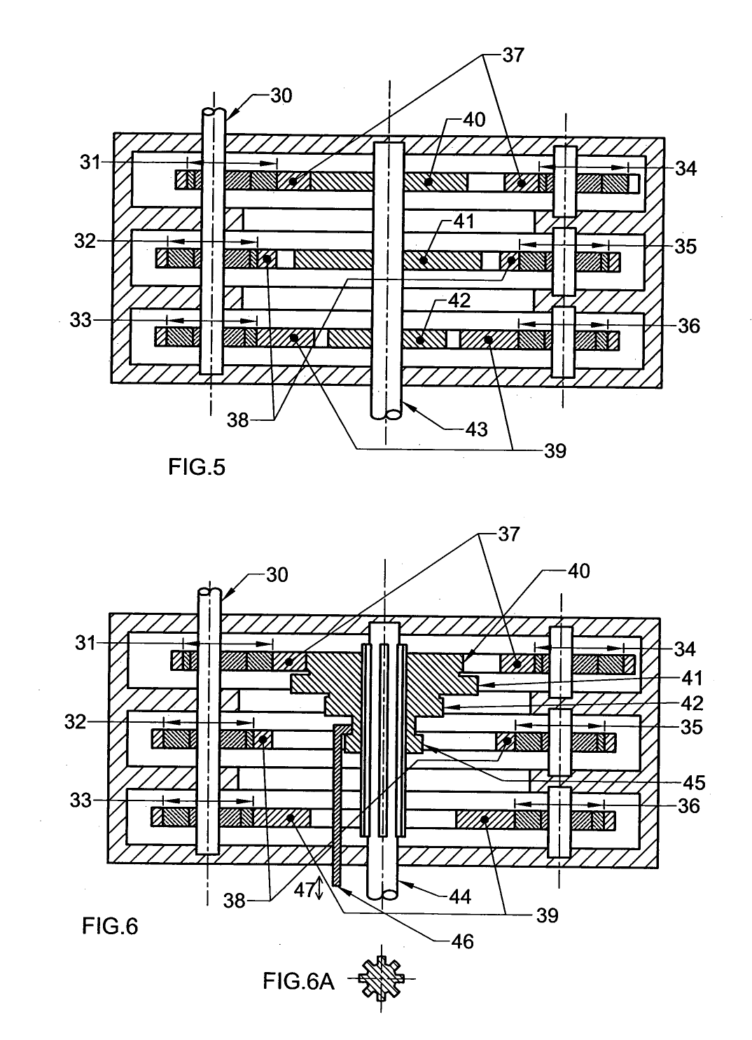

FIG. 5: Schematic representation of an eccentric gearbox with three eccentric gear pairs, one input shaft, one output shaft with multiple VEAs for each eccentric gear pair. One eccentric gear pair is engaged between input and output shafts and other two are in an out of engagement state.

FIG. 6: Schematic representation of an eccentric gearbox with three eccentric gear pairs; fixed gears of all the eccentric gear pairs are supported by multiple VEAs. Revolving gears of all the eccentric gear pairs together are mounted on a splined output shaft. A schematic gearshift mechanism moves the cluster of the revolving gears to engage one of the revolving gears to corresponding fixed gear. Unengaged fixed gears are made stationary by reducing eccentricity of corresponding VEAs to zero.

FIG. 6A: Cross-sectional view of the splined output shaft that is shown in FIG. 6, taken at a plane normal to the axis of it.

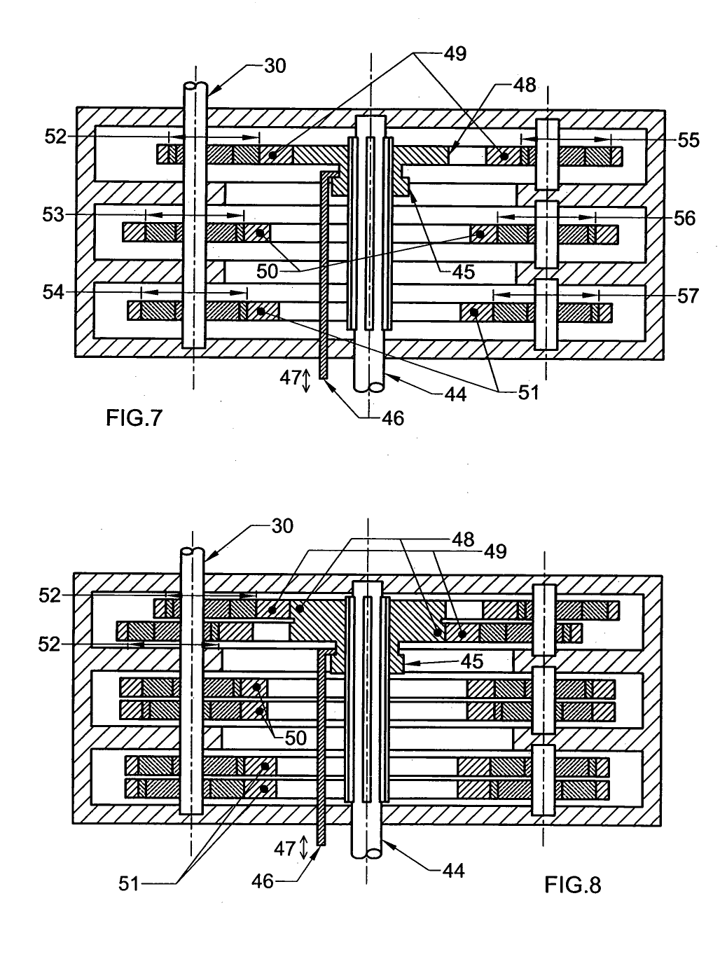

FIG. 7: Schematic representation of an eccentric gearbox with three eccentric gear pairs that have a common revolving gear. Fixed gears are mounted on multiple VEAs. A gearshift mechanism appropriately moves the common revolving gear to engage with one of the fixed gears.

FIG. 8: Schematic representation of an eccentric gearbox with three pairs of identical fixed gears while single pair of identical revolving gears is engage able to the fixed gears through a gearshift mechanism.

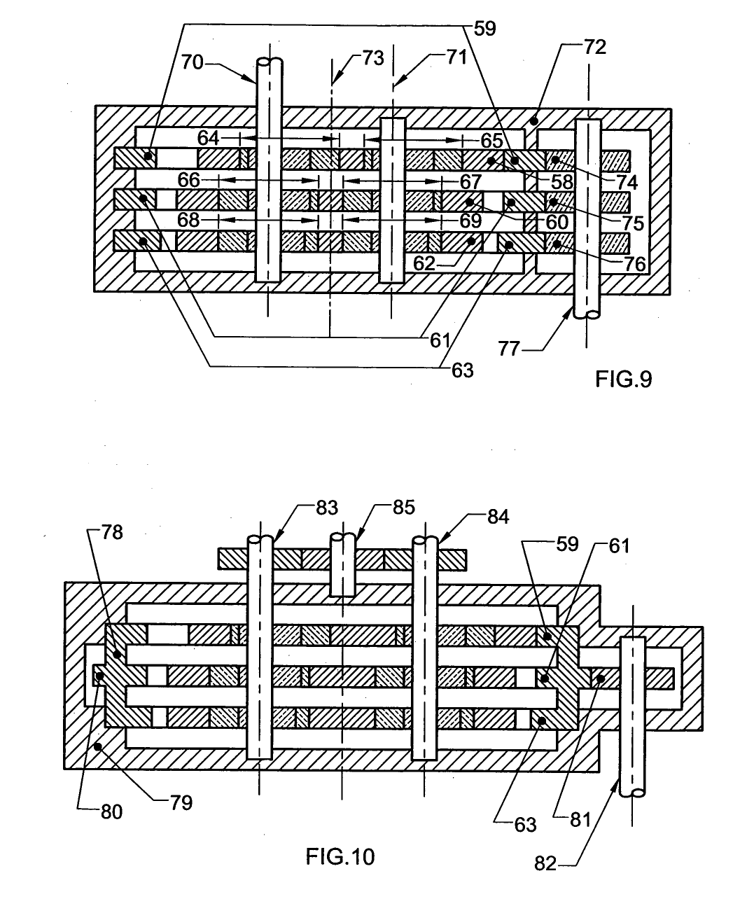

FIG. 9: Schematic representation of an eccentric gearbox with three eccentric gear pairs while internal gears are shown as revolving gears and the external gears are shown as fixed gears. Individual fixed gear is supported by multiple VEAs.

FIG. 10: Schematic representation of an eccentric gearbox with three eccentric gear pairs while internal gears are shown as revolving gears and the external gears are shown as fixed gears. Individual fixed gear is supported by multiple VEAs and two input shafts drive the VEAs. A common output gear that is mounted on the output shaft is engaged with the revolving gears.

### DETAILED DESCRIPTION

The invention is described in details with the help of the figures listed above. In different arrangements, like components are represented by same identification numbers for ease of understanding.

FIG. 1 shows two VEAs, each of which comprises of two eccentric parts 1, 2 and 3, 4 in series and a shafts 5 and 6 with its fixed axis of rotation respectively. In the figure, an eccentric gear pair is also shown with its fixed gear 7, in this case an internal gear, is mounted with the VEAs and its revolving gear 8, in this case an external gear, is mounted on the output shaft 9. The fixed and revolving gears of the eccentric gear pair are shown engaged with overall eccentricity 10 of the VEAs is equal to the eccentricity 11 of the eccentric gear pair. For ease of understanding eccentricities of the individual outer eccentric parts 1, 3 and inner eccentric parts 2, 4 respectively, are considered equal.

FIG. 2 shows eccentric gear pair 7, 8 in an out of engagement state as overall eccentricity of the VEAs is changed to zero by rotating outer eccentric parts with respect to corresponding inner eccentric parts. As eccentricity of the VEAs is changed to zero, axes of fixed gear 7 and revolving gear 8 are aligned. Changing eccentricity of VEAs to zero corresponding to an eccentric gear pair, makes its fixed gear stationary and thus does not absorb any power from the input shaft; additionally as in this case, inertia of the corresponding VEAs will also be less, and wastage of energy will further be reduced.

Thus from FIG. 1 and FIG. 2, it can be seen that by controlling eccentricity of the VEAs, gears of an eccentric gear pair can be engaged or disengaged.

FIG. 3 shows a schematic gearbox with two eccentric gear pairs 12, 13 and 14, 15 with internal gears 12 and 14 as fixed gear and external gears 13 and 15 as revolving gears. Individual fixed gears 12 and 14 are mounted with two VEAs 16 and 17 that are mounted on input shafts 18 and 19 with their fixed axes of rotation respectively. Circular gears 20 and 21 are fixed at one end of input shafts 18 and 19 as to rotate with respective shafts. Main input shaft 22 is fixed with a circular gear 23 at its one end as to rotate together. Revolving gears 13 and 15 are fixed to a coaxial output shaft 24 as to rotate with the shaft. Gear 23 is simultaneously in mesh with gears 20 and 21. FIG. 3 shows an eccentric gear pair 12, 13 in engaged condition and another eccentric gear pair 14, 15 in out of engagement condition with overall eccentricity of respective VEAs 16 and 17 equal to the eccentricity of eccentric gear pair 12, 13 and zero respectively. FIG. 3 shows eccentric gearbox with two input shafts, an eccentric gearbox can be made with more number of input shafts.

FIG. 4 shows another arrangement of the eccentric gearbox as shown in FIG. 3 with a single input shaft instead of two input shafts. The two fixed gears 12 and 14 are mounted with multiple VEAs, with one VEA 16 and 17 belonging to each fixed gear is mounted on input shaft 25 as to rotate with it. Other VEAs 26 and 27 are mounted on respective shafts 28 and 29 with their fixed axis as to maintain the orientation of the respective fixed gears 12 and 14. Eccentricity of VEAs 16 and 26 is always same and varies simultaneously; similarly, eccentricity of VEAs 17 and 27 is also same and varies simultaneously. Revolving gears 13 and 15 are coaxially mounted on the output shaft 24 as to rotate with it.

Functioning of gearbox shown in FIG. 3 and FIG. 4 are similar. In FIG. 3, input rotation is given to input shafts 18 and 19 through meshing gears 20, 23 and 21 and in FIG. 4, input rotation is directly given to the input shaft 25. In both the cases when input rotation is given to the input shafts 18 and 19 or 25, VEAs 16 and 17 connected to it rotate with the respective shafts. Eccentricity of VEAs 16 and 17 is changed as to engage one of the revolving gears 13 and 15 to the corresponding fixed gear 12 and 14 of the eccentric gear pairs. Eccentricities of VEAs 26 and 27 are either changed simultaneously with VEAs 16 and 17 or it can be designed to simultaneously follow eccentricity of VEAs 16 and 17 respectively. If eccentricity of VEAs 16 or 17 is made sufficiently less than the tooth height of gears of respective eccentric gear pairs than corresponding gears can be disengaged. Similarly if the eccentricity of the VEAs is changed to half the difference between pitch diameters of the two gears of a corresponding eccentric gear pair, then respective gears get properly engaged. Thus any of the eccentric gear pair can be engaged between input and output shaft by appropriately changing eccentricity of respective VEAs, while fixed gears of other eccentric gear pairs can be kept stationary as to reduce power consumption and wear and tear of the gears by changing eccentricity of VEAs belonging to other eccentric gear pairs to zero.

The mechanism, as described above with the help of FIG. 1 to FIG. 4, of changing eccentricity of respective VEAs to engage or disengage gears of a desired eccentric gear pair is used further in different arrangements of gears in an eccentric gearbox. Different arrangements of gears in an eccentric gearbox are explained further with the help of drawings, in which the figures show cross sections of the gearbox when taken along cut plane passing through an input shaft and output shaft. In sectional views, the gears are shown without teeth and only up to the pitch circle of the gears, thus two gears in mesh show a common line between them as the point or line of contact between respective pitch circles or respective pitch cylinders. Fixed axes of VEAs 26, which are not connected to input shafts, need not be aligned to that of similar VEAs 27 belonging to different eccentric gear pairs.

Arrangement of eccentric gearbox shown in FIG. 5 is similar to that shown in FIG. 4, and has three eccentric gear pairs as compared to two in FIG. 4. The eccentric gearbox shown in FIG. 5 give three speed ratios between the input and output shafts. FIG. 5 shows a schematic sectional view of an eccentric gearbox, taken at cutting plane passing through axes of an input shaft and output shaft. Input shaft 30 is mounted with VEAs 31, 32, and 33 as to rotate with the input shaft. Additional VEAs 34, 35 and 36 are also mounted along with VEAs 31, 32, and 33 on the respective fixed gears 37, 38, and 39. Revolving gears 40, 41, and 42 are mounted on output shaft 43 as to rotate with it without slip. Gears 37, 38, 39, 40, 41, and 42 are not free to move in direction along the axis of input shaft 30. All the VEAs corresponding to a fixed gear simultaneously change its eccentricity. In the figure, only eccentric gear pair 37, 40 is shown engaged between input shaft 30 and output shaft 43, gears belonging to other eccentric gear pairs 38, 41 and 39, 42 are not meshing. Thus, speed ratio obtained between input and output shafts is the speed ratio decided by the eccentric gear pair whose gears are made meshing with each other by appropriately changing eccentricity of respective VEAs.

FIG. 6 schematically shows another eccentric gearbox with three eccentric gear pairs. The arrangement uses similar eccentric gear pairs as in FIG. 5, thus like components in FIG. 6, are given same identification numbers. Revolving gears 40, 41, and 42 belonging to the eccentric gear pairs (37, 40), (38, 41), and (39, 42) are mounted together as a single moving assembly on a splined output shaft 44 in such a way that it can move with respect to fixed gears, along the shaft axis and continue to rotate with the shaft 44. Schematic section of the output shaft is shown in FIG. 6A. A collar 45 is attached to the moving assembly. A schematic gearshift mechanism 46 is employed to move the collar and thus the moving assembly in direction 47 along the shaft axis. The moving assembly is appropriately locked in a position on the output shaft 44 as to mesh one of the revolving gears 40, 41, and 42 with corresponding fixed gear 37, 38, and 39 respectively. Thus by locking moving assembly with respect to the fixed gears, in an appropriate position on the output shaft, any of the eccentric gear pairs can be engaged between the input and output shafts. Simultaneously by appropriately changing eccentricities of various VEAs, proper engagement of a revolving gear with corresponding fixed gear can be assured while non-engaged fixed gears can be made stationary by changing eccentricities of corresponding VEAs to zero.

In yet other arrangement for a gearbox as in FIG. 6, all the VEAs can be replaced with fixed eccentricity eccentric parts. Such that VEAs 31 and 34 are replaced by eccentric part with eccentricity equal to that of eccentric gear pair 37, 40. Similarly VEAs 32, 35 and VEAs 33, 36 are replaced with eccentric parts with eccentricities equal to that of the eccentric gear pairs 38, 41 and 39, 42 respectively. In such arrangement all the fixed gears will continue to revolve and maintain their fixed orientation. The moving assembly can be moved with respect to fixed gears and locked on the output shaft as to engage any eccentric gear pair between the input and output shafts.

Yet another arrangement of an eccentric gearbox is shown in FIG. 7, which has a common revolving gear 48 for all fixed gears 49, 50, and 51, thus forming eccentric gear pairs (48, 49), (48, 50), and (48, 51). All fixed gears of the eccentric gear pairs should have gear tooth profile to match with that of common revolving gear 48. Revolving gear 48 along with collar 45, is mounted on splined output shaft 44 as to rotate with the shaft without slip. A schematic gearshift mechanism is employed to move the common revolving gear in direction 47 along the shaft axis and to lock it on the output shaft as to mesh it with one of the fixed gears 49, 50, 51 as required. Input shaft 30 is attached with VEAs 52, 53, and 54 that are mounted on the fixed gears 49, 50, and 51 respectively. The VEAs rotate with the input shaft. Additional VEAs 55, 56, and 57 with respective fixed axes, are also mounted on the respective fixed gears as to have eccentricities equal to that of VEAs 52, 53, and 54 respectively. By changing eccentricities of the VEAs 52, 53, and 54 and simultaneously moving and locking the common revolving gear with respect to fixed gears, on the output shaft any eccentric gear pair can be engaged between the input and the output shafts. For proper engagement, eccentricity of the VEAs corresponding to the fixed gear that is to be engaged with the common revolving gear should preferably be equal to the eccentricity of the eccentric gear pair formed by respective fixed gear and the common revolving gear.

In another arrangement of an eccentric gearbox, fixed gear can be made common and can be made movable with respect to the revolving gears along the axis of revolving gears, while the revolving gears are connected to the output shaft as to rotate with it without slip. Different eccentric gear pairs are formed by meshing the common fixed gear with one of the revolving gears at a time by moving common fixed gear along the axis and simultaneously changing eccentricity of corresponding VEAs to suit the eccentricity of the formed eccentric gear pair. Thus, any of the eccentric gear pairs can be engaged between input and output shafts.

In another arrangement for a gearbox as in FIG. 7, VEAs 52, 55, 53, 56, 54, and 57, can be replaced with appropriate eccentric parts with fixed eccentricity equal to the eccentricities of respective eccentric gear pairs (48, 49), (48, 50), and (48, 51). Engagement of common revolving gear 48 with selected fixed gear can be done the same way as done for the gearbox in FIG. 7, by appropriately moving it and locking it on the output shaft. Because of the eccentric parts with fixed eccentricity, axes of fixed gears will continue to revolve around the output shaft axis irrespective of its being engaged or not with the common revolving gear 48.

FIG. 8, schematically shows an arrangement for the gearbox as in FIG. 7, that uses two identical eccentric gear pairs being engaged simultaneously between input and output shafts. Thus, there are two identical common revolving gears 48 along with two identical fixed gears 49, 50, 51 each. Similarly set of VEAs are also in pair with one set for one fixed gear and other for the identical fixed gear. As shown in FIG. 8, two fixed gears 49 are meshing with the two common revolving gears 48 at diametrical opposite ends, which balance eccentric forces coming onto the input and output shafts, accordingly eccentricities of the two VEAs, corresponding to the engaged eccentric gear pairs, have appropriate phase difference between them. Thus, VEAs are arranged in such a way that eccentricities of the VEAs for the identical fixed gears that are meshing with identical common revolving gears are at appropriate phase difference. In yet another arrangement the VEAs can be replaced with fixed eccentricity eccentric parts, for that eccentricity of the eccentric parts corresponding to the identical fixed gears that simultaneously mesh with the identical common revolving gears can be set at appropriate phase difference. The eccentric parts connected to the input shaft rotate with the input shaft. Change of engaged eccentric gear pairs between input and output shafts is done by appropriately moving and locking the common revolving gears on the output shaft.

In above examples external gear of an eccentric gear pair is considered as the revolving gear and internal gear as the fixed gear. In other arrangements internal gear can be considered as a revolving gear while external gear can be considered as a fixed gear. In such cases mounting of the revolving gear on the output shaft will be difficult as the axis of the internal gear, which is a revolving gear, passes through the external gear, which is fixed gear. Thus, internal gears as revolving gears can be mounted on a coaxial drum as to rotate without slip with the drum while the drum can be connected to a coaxial output shaft. Or, in other arrangements with internal gears as the revolving gears, which rotate about a fixed axis or the drum, can be coupled to a separate output shaft and the rotation of the revolving gears can be transferred to the output shaft. Two examples of such arrangements that use the internal gear as the revolving gear are described below.

Eccentric gearbox in FIG. 9 consists of eccentric gear pairs (58, 59), (60, 61) and (62, 63) with external gears 58, 60, 62 and internal gears 59, 61, 63 respectively. External gears 58, 60, and 62 are fixed gears and thus mounted with VEAs 64, 65, 66, 67, 68, and 69 respectively. One of the VEAs belonging to each fixed gear is mounted on input shaft 70 as to rotate without slip with it. Other VEAs as one or multiple of 65, 67, and 69, belonging to the fixed gears are having individual fixed axis for their rotation. In FIG. 9, one common fixed axis 71 is shown as the axis of rotation for VEAs 65, 67, and 69, but the VEAs that are not connected to the input shaft can have separate individual fixed axis of rotation. Internal gears 59, 61, and 63 are the revolving gears and are supported by frame 72 as to revolve around axis 73. On the outer periphery of these revolving gears 59, 61, and 63 external gear teeth are provided that mesh with external gears 74, 75, and 76 fixed to an output shaft 77 as to rotate with the output shaft. By appropriately changing eccentricity of respective VEAs, gears belonging to any of the eccentric gear pairs can be engaged while other are kept out of engagement. Fixed gears of disengaged eccentric gear pairs can be made stationary by appropriately changing eccentricities of respective VEAs to zero. Thus, any of the speed ratios that can be obtained from any one of the eccentric gear pairs and the speed ratio obtained from meshing of gears 74, 75, and 76 with respective revolving gears can be obtained between input shaft 70 and output shaft 77 as a product of the two speed ratios.

In yet another arrangement as shown in FIG. 10, with reference to FIG. 9, revolving gears 59, 61, and 63 are mounted on a drum 78 that is supported by the frame 79 and has external teeth 80 on its outer periphery. External teeth 80 are in mesh with an external gear 81 that is mounted on an output shaft 82 as to rotate with it without slip.

By changing eccentricities of respective VEAs, any of the eccentric gear pairs can be engaged between the input and output shaft.

In another arrangement, external gears 74, 75, and 76 can be replaced with a single gear that can move in a direction along the axis of output shaft while continue to rotate with it. With a gearshift mechanism, the single gear can be moved to mesh with respective revolving gear of the eccentric gear pair that is in engagement.

In yet another arrangement as shown in FIG. 10, and which is similar to that shown in FIG. 3, multiple input shafts 83 and 84 can be coupled through meshing gears to a main input shaft 85. Fixed gears, in this case external gears, are mounted with multiple VEAs, and input shafts 83, 84 each are connected with one VEAs for each fixed gears.

The arrangements as shown in FIG. 1 to FIG. 8 for the eccentric gearbox with external gears as revolving gears can suitably be used for eccentric gearbox with internal gears as revolving gears. The difference in the two gearbox, one with external gear as revolving gear and one with internal gear as revolving gear is that in later case axis of rotation for the revolving gears pass through the fixed gears and thus connection between output shaft and revolving gears is not as straight forward as in the former case. In former case, axis of rotation of revolving gears pass through them and thus an output shaft can be easily connected to them as to rotate with them. Instead of the splined shaft that is used in former case, in later case, a drum that rotate about the axis of the revolving gears, can be made with splines on it and connected to an output shaft while revolving gears with matching splines can move along the axis of the drum.

A person skilled in the art can use the arrangements for fixed and revolving gears that are used in FIG. 1 to FIG. 8 to make an eccentric gearbox with external gears as fixed gears and internal gears as revolving gears.

In eccentric gearbox as described above with revolving gears that move along the direction of its axis of rotation, VEAs can be replaced by fixed eccentricity eccentric parts and engagement of a revolving gear with corresponding fixed gear can be done by appropriately moving and locking the revolving gear along its axis. In such cases, fixed gears will continue to revolve around the axis of the revolving gear without changing its orientation.

It is possible to make few of the VEAs or eccentric parts that are connected to the input shaft as to rotate with respect to the input shaft, by doing so, transfer of load from un-engaged fixed gear to the input shaft can be reduced. It is also possible to employ a gearshift mechanism to appropriately change eccentricities of various VEAs connected to the input shaft as to control engagement of any desired eccentric gear pair between input and output shaft and to control eccentricity of un-engaged fixed gears appropriately.

It is possible to use combination of fixed eccentricity eccentric parts along with VEAs. Thus if the eccentric part connected to the input shaft is of fixed eccentricity eccentric part then other eccentric parts corresponding to that fixed gear are either VEAs or fixed eccentricity eccentric parts, and if a VEA is connected to the input shaft then all the eccentric parts corresponding to that fixed gear are VEAs. In an eccentric gear pair with VEAs, maximum eccentricity of the VEAs can be set more than the eccentricity of corresponding eccentric gear pair and control of VEA can be done in such a way that it can compensate for wear and tear of the gears of the eccentric gear pair in due course of time.

In all the above-mentioned gearboxes additional eccentrics, eccentric parts, VEAs and related identical revolving and fixed gears or additional identical eccentric gear pairs can be used simultaneously with appropriate phase difference. This may reduce vibration and increase balancing in the gearbox. For the parts, which are free to rotate, appropriate use of bearings will reduce friction. In above description gear teeth are not shown for simplicity of understanding. Proper lubrication scheme has to be worked out as per the specific application.

Advantages of the Eccentric Gearbox:
1. In an automobile use of eccentric gearbox can reduce the size of gearbox for the same effective speed ratios between input and output shafts.
2. Variable eccentric assemblies are used to make few fixed gears stationary as to save energy wastage that would otherwise have been consumed by un-engaged fixed gears for their revolutions. This also reduces vibration of gearbox, as the fixed gears revolve at very high rotational speeds as compared to that of the revolving gears.
3. By disengaging the fixed gear and revolving gear of an eccentric gear pair, wear and tear of the gears can be reduced.
4. Use of common revolving gear for multiple fixed gears as to form different eccentric gear pairs reduces inertia attached to the output shaft.
5. Use of common fixed gear for multiple revolving gears as to form different eccentric gear pairs reduces inertia attached to the input shaft, which generally rotate at high speeds.
6. Number of identical gears can be different for different eccentric gear pairs in an eccentric gear box as to support different load pattern and proper balancing of different eccentric gear pairs.
7. Number of identical gears for an eccentric gear pair can be more than two for better balancing of the eccentric gear pair.

1. An eccentric gear box consisting of at least one gearshift mechanism, at least two eccentric gear pairs with different ratios between number of teeth on its gears, at least one input shaft, at least one output shaft and multiple eccentric parts;
wherein the eccentric gear pair consists of one circular gear, with internal gear teeth and another circular gear with external gear teeth; wherein number of external gear teeth is less than the number of internal gear teeth; wherein one of the gears of eccentric gear pair is a revolving gear and the other gear is a fixed orientation gear;
wherein multiple eccentric parts are mounted on fixed orientation gear as to keep its orientation fixed while allowing its axis to revolve around the axis of revolving gear; revolving gears can revolve around its axis; individual eccentric part revolves around its fixed axis and is free to revolve with respect to the associated fixed orientation gear;
wherein at least one eccentric part associated with each fixed orientation gear is mounted on input shaft as to rotate with it and revolving gears associated with different eccentric gear pairs are connected to output shaft as to rotate with the output shaft; wherein revolving gears are movable with respect to fixed orientation gears in a direction along its axis;
wherein at least one gearshift mechanism is employed to move revolving gear along its axis to engage it with a fixed orientation gear as to select an eccentric gear pair to be effectively engaged between input shaft and output shaft.

2. An eccentric gearbox as claimed in claim 1 wherein at least one revolving gear is common to at least two different eccentric gear pairs and at a time it can engage with one of the fixed orientation gears belonging to different eccentric gear pairs.

3. An eccentric gearbox as claimed in claim 1 or 2 wherein instead of eccentric parts, variable eccentricity assemblies are mounted on at least one fixed orientation gear, and by changing eccentricity of the variable eccentricity assemblies, distance between axes of the fixed orientation gear and associated revolving gear is changed.

4. An eccentric gear box consisting of at least one gearshift mechanism, at least two eccentric gear pairs with different ratios between number of teeth on its gears, at least one input shaft, at least one output shaft and multiple variable eccentricity assemblies;
wherein the eccentric gear pair consists of one circular gear, with internal gear teeth and another circular gear with external gear teeth; wherein number of external gear teeth is less than the number of internal gear teeth; wherein one of the gears of eccentric gear pair is a revolving gear and the other gear is a fixed orientation gear;
wherein multiple variable eccentricity assemblies are mounted on fixed orientation gear as to keep its orientation fixed while allowing its axis to revolve around the axis of revolving gear; revolving gears can revolve around its axis; individual variable eccentricity assembly revolves around its fixed axis and is free to revolve with respect to the associated fixed orientation gear;
wherein one variable eccentricity assembly associated with each fixed orientation gear is mounted on an input shaft as to rotate with it and revolving gears associated with different eccentric gear pairs are connected to output shaft as to rotate with the output shaft;
wherein at least one gearshift mechanism is employed to change eccentricity of at least one variable eccentricity assembly as to engage corresponding fixed orientation gear with respective revolving gear, while maintaining variable eccentricity assemblies corresponding to other fixed orientation gears at sufficiently lower values such that the fixed orientation gears does not engage with corresponding revolving gears;
wherein the engagement of a fixed orientation gear with corresponding revolving gear causes engagement of respective eccentric gear pair between input and output shafts.

5. An eccentric gearbox as claimed in claim 4 wherein at least one fixed orientation gear, which is common to at least two different eccentric gear pairs and is movable with respect to revolving gears in the direction along the axis of revolving gear;
Wherein at least one gearshift mechanism moves the movable fixed orientation gear in the direction along the axis of revolving gear, as to engage it with one of the revolving gears, while eccentricity of corresponding variable eccentricity assemblies is changed to suit eccentricity of eccentric gear pair consisting of the fixed orientation gear and the revolving gear that are being engaged, as to engage the eccentric gear pair between input and output shafts.

6. An eccentric gearbox as claimed in claims 1 to 5 wherein one of the eccentric parts or one of the variable eccentricity assemblies belonging to the engaged eccentric gear pair is fixed to the input shaft and other eccentric parts or other variable eccentricity assemblies respectively are free to rotate with respect to the input shaft.

7. An eccentric gearbox as claimed in claims 1 to 6 wherein at least one of the revolving gears belonging to the eccentric gear pair engaged between input and output shafts, is coupled to the output shaft as to rotate with the output shaft without slip, while other revolving gears are free to rotate with respect to the output shaft.

8. An eccentric gearbox as claimed in claims 1 to 7 wherein the output shaft is not coaxial to the revolving gears and is coupled to at least one of the revolving gears as to revolve with it without slip.

9. An eccentric gear box as claimed in claims 1 to 8 that consists of at least one additional eccentric gear pair that is identical to one of the eccentric gear pairs of the eccentric gear box; wherein corresponding components belonging to the identical eccentric gear pairs simultaneously engaged the identical eccentric gear pairs between the input and the output shafts respectively.

10. An eccentric gearbox as claimed in claims 1 to 8 in which the input shaft is used as output shaft and the output shaft is used as input shaft.
